(19) United States
(12) Patent Application Publication
(10) Pub. No.: US 2004/0039945 A1
(43) Pub. Date: Feb. 26, 2004

(54) Authentication method and authentication apparatus

(76) Inventor: Yoshihiro Oda, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/630,010

(22) Filed: Jul. 30, 2003

(30) Foreign Application Priority Data
Aug. 23, 2002 (JP) 2002-243577

(51) Int. Cl. H04L 9/32; G06F 15/16

(52) U.S. Cl. 713/201; 709/227

(57) ABSTRACT

In an authentication method for using a plurality of Web servers to allow only a user in a certain group to access information in the Web servers, a first Web server has a restricted access domain that only the user in the certain group is allowed to access from a client terminal, and does not have authentication information regarding the user. A second Web server has the restricted access domain that only the user in the certain group is allowed to access and further has the authentication information registered thereto. The first Web server delivers an authentication request to the second Web server. Based on authentication results determined by the second Web server, the first Web server allows the user to access the information. As a result, it is possible to reduce both user's work load for using a Web server to which the authentication method is applied and administrator's work load for managing the Web server.

### CROSS-REFERENCE TO RELATED APPLICATIONS

The present application is based on Japanese priority application No. 2002-243577 filed Aug. 23, 2002, the entire contents of which are hereby incorporated by reference.

### BACKGROUND OF THE INVENTION

1. Field of the Invention

The present invention generally relates to authentication methods and apparatuses thereof, and more particularly to an authentication method and an authentication apparatus for permitting only users in a certain group to access a restricted domain by use of a plurality of Web servers.

2. Description of the Related Art

At present, a Web server plays a significant role of information services as a provider of Web pages. In such a circumstance, there arise two strong demands. One is the demand for distributing information and processes to a plurality of Web servers. The other is the demand for restricting access to certain Web pages in a Web server. For the two demands, it is desired to design an authentication method and an authentication apparatus that can use a plurality of Web servers to provide access-restricted Web pages therein to only a certain group of users.

In order to use the Web servers to individually manage such an access-restricted Web page, each of the Web servers needs to possess a common authentication function therein.

Conventionally, a Web server adopts an authentication method for authenticating an access of a user to a restricted Web page in the Web server by using an ID and a password of the user as authentication information. In order to apply the conventional authentication method to a plurality of Web pages, it is necessary for the user to register the ID and the password to every one of the Web servers. Otherwise, it is necessary to provide the Web servers with a scheme whereby the Web servers can mutually refer to the ID and the password by using a certain tool or adopting a certain system.

When information service providers use a plurality of Web servers to manage an access-restricted Web page therein by means of an ID and a password of a user, the information service providers have conventionally adopted the following authentication methods.

In the first conventional authentication method, a user is required to register authentication information of the user, which typically comprises an ID and a password of the user, with every one of the above Web servers.

In the second conventional authentication method, a user is required to register authentication information of the user with one of the above Web servers. A server administrator or a certain tool copies the registered authentication information and then provides the copied authentication information to the other Web servers.

In the third conventional authentication method, the above Web servers use a certain tool to share authentication information that an individual user registers to one of the Web servers.

In the fourth conventional authentication method, a specified server is prepared for the above Web servers. A user registers authentication information of the user to the specified server. The Web servers use a certain tool of the specified server to obtain the authentication information.

However, these conventional authentication methods have the following problems.

According to the first conventional authentication method, the user needs to separately register authentication information to all the Web servers. In this case, there is a probability that the user registers a mistaken ID or a mistaken password or forgets the correct ID or the correct password. Also, since an administrator of the individual Web servers needs to independently manage authentication information, the management of the authentication information causes a heavy work load for the administrator.

According to the second conventional authentication method, every user registers authentication information with one of the Web servers and then the registered authentication information is copied to the other Web servers. In this case, in order to accurately copy the authentication information, administrators need to perform some operations related to the registration for the Web servers of the administrators. Otherwise, the administrators need to prepare a certain tool for the Web servers. Furthermore, it is difficult to properly manage a scheme for the timely updating of the authentication information in all the Web servers without any delay.

According to the third conventional authentication method, the Web servers need to prepare a certain system for sharing authentication information among the Web servers and cooperate each other. In this case, such a system cannot help becoming complicated. As a result, there arises an increasing burden regarding the management of the system.

According to the fourth conventional authentication method, the specified server is responsible for managing all IDs and passwords registered by the users. In this case, in order to obtain authentication information, the Web servers have to possess a certain tool or a certain function for accessing the specified server. For instance, when a directory server is used to manage authentication information for an access-restricted Web page, it is necessary to register additional information for restricting an access to the Web page with the directory server such as information indicating which user can access which Web page in the Web servers. As a result, there arises an increasing burden regarding the registration and the management of such additional information.

For instance, when the Web servers obtain registered authentication information from the above-mentioned directory server in accordance with LDAP (Lightweight Directory Access Protocol), it is necessary to register authentication information and additional information indicating which domain and pattern are restricted with the directory server.

### SUMMARY OF THE INVENTION

It is a general object of the present invention to provide an authentication method and an authentication apparatus in which the above-mentioned problems are eliminated.

A more specific object of the present invention is to provide an authentication method and an authentication apparatus that permit only users in a certain group to access a restricted domain in a plurality of Web servers with reduced tasks for the users and a reduced burden regarding the management of Web servers.

In order to achieve the above-mentioned objects, there is provided according to one aspect of the present invention an authentication method for using a plurality of Web servers to allow only a user in a certain group to access information in the Web servers, wherein a first Web server in the Web servers has a restricted access domain that only the user in the certain group is allowed to access from a client terminal and does not have authentication information regarding the user, and a second Web server in the Web servers has a restricted access domain that only the user in the certain group is allowed to access and further has the authentication information registered thereto, comprising the steps of: causing the first Web server to request authentication to the second Web server; and allowing the user to access the restricted access domain in the first Web server from the client terminal based on an authentication result provided to the first Web server by the second Web server.

According to the above-mentioned invention, it is possible to reduce both user's work load for using a Web server to which the authentication method is applied and administrator's work load for managing the Web server.

In the above-mentioned authentication method, the first Web server may deliver an authentication information request received from the second Web server to the client terminal and then may deliver authentication information received from the client terminal for the authentication information request to the second Web server.

According to the above-mentioned invention, it is possible to properly implement the above-mentioned authentication method.

In the above-mentioned authentication method, the second Web server may receive an authentication request from a plurality of first Web servers.

According to the above-mentioned invention, since the second Web server receives authentication requests from a plurality of the first Web servers, it is possible to use only the second Web server to authenticate the authentication requests from a plurality of the first Web servers.

In the above-mentioned authentication method, the first Web server may deliver an authentication request to a plurality of second Web servers.

According to the above-mentioned invention, since the first Web server delivers authentication requests to a plurality of the second Web servers, it is possible to authenticate the authentication requests by using the second Web servers corresponding to individual groups.

In the above-mentioned authentication method, the first Web server may deliver an authentication request to another first Web server and said other first Web server may deliver the authentication request to the second Web server.

According to the above-mentioned invention, it is possible to authenticate the authentication request by using the second Web server where the authentication request eventually arrives via a plurality of the first Web servers.

Additionally, there is provided according to another aspect of the present invention an authentication apparatus for allowing only a user in a certain group to access information in a restricted access domain therein, comprising: an authentication requested Web server registering part registering a Web server as an authentication requested Web server, the Web server having the same restricted access domain as the restricted access domain in the authentication apparatus and further having authentication information regarding the user registered thereto; and an authentication requesting part requesting authentication to the Web server with reference to the authentication requested Web server registering part when the authentication requesting part receives an access request for accessing the restricted access domain therein from a client terminal of the user, wherein the Web server determines whether or not the authentication is valid and the access request is authenticated based on an authentication result determined by the Web server.

According to the above-mentioned invention, it is possible to reduce both user's work load for using a Web server to which the authentication method is applied and administrator's work load for managing the Web server.

In the above-mentioned authentication apparatus, the authentication requesting part may deliver an authentication information request received from the Web server to the client terminal and may deliver authentication information supplied for the authentication information request by the client terminal to the Web server.

According to the above-mentioned invention, it is possible to properly implement the above-mentioned authentication apparatus.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating a fundamental mechanism of an authentication method according to the present invention;

FIG. 2 is a diagram explaining a process flow of the authentication method according to the present invention when a user requests an access-restricted Web page in a restricted access domain;

FIG. 3 is a diagram illustrating a comparison of the process flow of the authentication method according to the present invention with an authentication process in which a Web server performs an entire authentication process by itself;

FIG. 4 is a diagram illustrating a case where some Web servers recursively perform the authentication process according to the present invention;

FIGS. 5A through 5C are diagrams illustrating typical configuration patterns of authentication requesting Web servers and master Web servers according to the present invention;

FIG. 6 is a diagram illustrating the system structure of an authentication apparatus according to a first embodiment of the present invention;

FIG. 7 is a diagram illustrating the system structure of an authentication apparatus according to a second embodiment of the present invention; and

FIG. 8 is a diagram illustrating an example of an authentication requested Web server's URL definition.

### DETAILED DESCRIPTION OF THE PREFERRED EMBODIMENTS

In the following, embodiments of the present invention will be described with reference to the accompanying drawings.

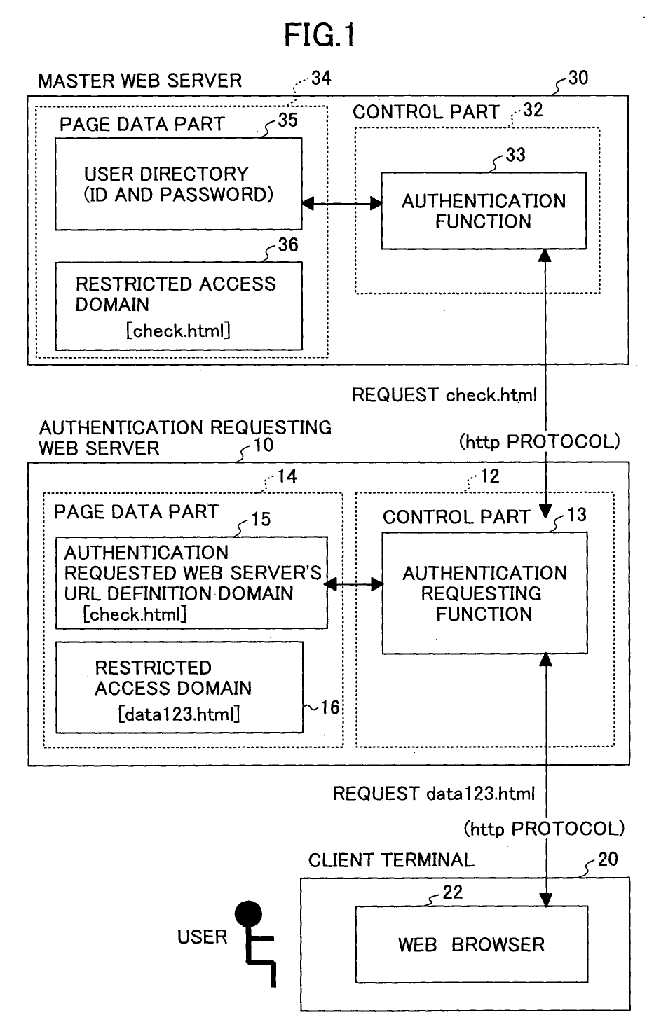

FIG. 1 shows a fundamental mechanism of an authentication method according to the present invention. In FIG. 1, an authentication requesting Web server 10 has a function according to the present invention. The authentication requesting Web server has a control part 12 and a page data part 14. The control part 12 has an authentication requesting function 13. The page data part 14 has an authentication requested Web server's URL definition domain 15 and a restricted access domain 16 that only users in a group U are allowed to access.

A user requests to access an access-restricted Web page in the authentication requesting Web server 10 through a Web browser 22 in a client terminal 20.

A master Web server 30 shown in FIG. 1 is formed of an ordinary Web server. However, this notation is used in this specification in order to distinguish the master Web server 30 from the authentication requesting Web server 10. The master Web server 30 serves to perform an authentication determination process by comparing authentication information that a user has registered in a user directory 35 in advance with authentication information (an ID and a password) that the user inputs through the Web browser 22 so as to access an access-restricted Web page. The master Web server 30 has a control part 32 and a page data part 34. The control part 32 has an authentication function 33 for performing the authentication determination process. The page data part 34 has the user directory 35 and a restricted access domain 36 that only users in the group U are allowed to access.

The authentication requesting Web server 10 has two further functions in addition to functions that the master Web server 30 has. The first function is related to the authentication requested Web server's URL definition domain 15 that is provided for access-restricted Web pages in the authentication requesting Web server 10 corresponding to the restricted access domain 16. The authentication requested Web server's URL definition domain 15 has a URL (Uniform Resource Locator) for referring to a restricted access domain of other Web servers, for instance, the restricted access domain 36 of the master Web server 30, which has the same access-restricted Web page as that in the authentication requesting Web server 10.

The second function is related to the authentication requesting function 13. The authentication requesting function 13 confirms the validity of authentication by accessing a URL of another Web server in the authentication requested URL definition domain 15. When a user attempts to access an access-restricted Web page in the restricted access domain 16, the authentication requesting function 13 determines whether or not the access is valid by accessing another Web server, for instance, the master Web server 30, and handing over an Id and a password input by the user to the accessed Web server.

As a result, even if the user accesses the Web server that possesses no authentication information regarding the user, the Web server can use the above two functions to provide the user with the requested access-restricted Web page through the authentication function of another Web server.

Here, the authentication requesting Web server 10 basically has the same functions as the master Web server 30. Thus, when a user accesses an access-free Web page in the authentication requesting Web server 10, the authentication requesting Web server 10 can provide the user with the access-free Web page without aid from another Web server.

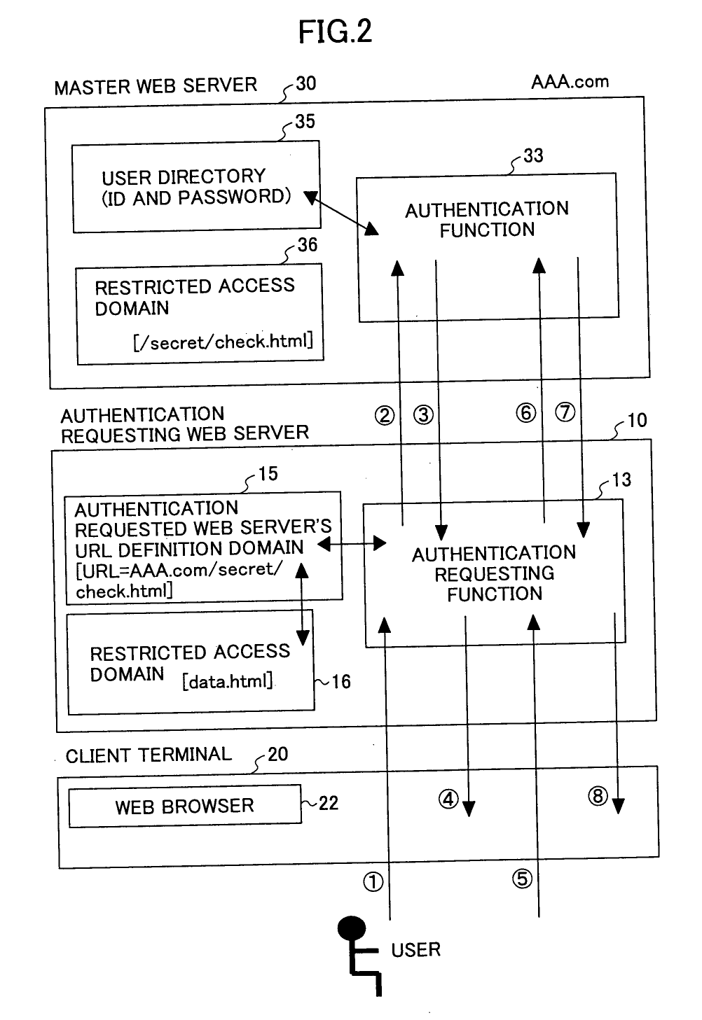

FIG. 2 shows a process flow of the authentication method according to the present invention when a user of a group U requests a Web page (data.html) in the restricted access domain 16 that only users in a group U are allowed to access.

Here, it is supposed that only the master Web server 30 has authentication information of the user in the user directory 35 thereof and the authentication requesting Web server 10 does not have the authentication information. Also, it is supposed that one of the access-restricted Web pages in the restricted access domain 36 in the master Web server 30 is “/secret/check.html”.

The authentication requesting Web server 10 maintains the URL “AAA.com/secret/check.html” of this access-restricted Web page “/secret/check.html” in the authentication requested Web server's URL definition domain 15 corresponding to the restricted access domain 16 thereof.

Now, a user is supposed to request an access-restricted Web page in the restricted access domain 16 in the authentication requesting Web server 10. If the authentication requesting Web server 10 has the authentication requested Web server's URL definition domain 15 corresponding to the restricted access domain 16, the authentication requesting function 13 of the authentication requesting Web server 10 does not perform the authentication process therein. The authentication requesting function 13 performs the authentication process by use of the master Web server 30 by accessing the designated URL “AAA.com/secret/check.html” in the authentication requested Web server's URL definition domain 15.

A detailed description will now be given, with reference to FIG. 2, of the process flow of the above-mentioned authentication process.

In the arrow \mathring{1}, a user requests the access-restricted Web page “data.html” in the restricted access domain 16 in the authentication requesting Web server 10 through the client terminal 20.

In the arrow \mathring{2}, the authentication requesting function 13 of the authentication requesting Web server 10 determines whether or not a URL corresponding to the requested access-restricted Web page “data.html” is in the authentication requested Web server's URL definition domain 15. If the corresponding URL “AAA.com/secret/check.html” is found in the authentication requested Web server's URL definition domain 15, the authentication requesting function 13 accesses the URL “AAA.com/secret/check.html”. In this case, the authentication requesting function 13 uses commands such as a page request command and a page update check command in HTTP protocol.

In the arrow \mathring{3}, when the URL “AAA.com/secret/check.html” in the restricted access domain 36 in the master Web server 30 is accessed, the master Web server 30 requests an ID and a password for the authentication requesting function 13 of the authentication requesting Web server 10.

In the arrow \mathring{4}, the authentication requesting Web server 10 requests the user to input the ID and the password of the user through the Web browser 22.

In the arrow \mathring{5}, when the input of the ID and the password is requested through the Web browser 22, the user inputs the ID and the password of the user.

In the arrow \mathring{6}, when the user inputs the ID and the password, the authentication requesting function 13 passes the ID and the password to the master Web server 30.

In the arrow \mathring{7}, if the ID and the password are determined to be valid, the authentication function 33 replies the authentication for the request to the authentication requesting Web server 10.

In the arrow \mathring{8}, when the authentication requesting Web server 10 receives the authentication, the authentication requesting Web server 10 provides the requested access-restricted Web page “data.html” in the restricted access domain 16 to the Web browser 22.

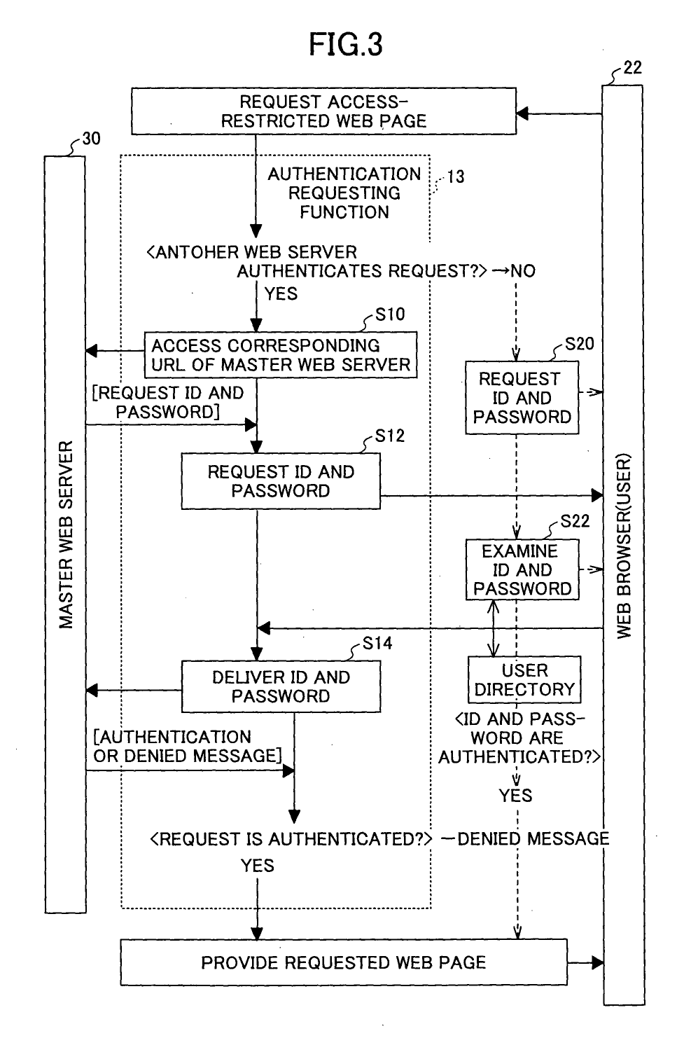

FIG. 3 shows a comparison of the process flow of the authentication requesting function 13 with the process flow of a conventional authentication method in the case where a Web server performs the entire authentication process by itself. As is shown with respect to solid arrows in FIG. 3, when an access-restricted Web page is requested, the authentication requesting function 13 accesses the corresponding URL in the master Web server 30 at step S10. When the master Web server 30 requests an ID and a password from the authentication requesting function 13, the authentication requesting function 13 passes the request to the Web browser 22 at step S12. When the ID and the password are provided through the Web browser 22, the authentication requesting function 13 passes the ID and the password to the master Web server 30. If the authentication requesting function 13 receives the authentication from the master Web server 30, the authentication requesting function 13 provides the requested access-restricted Web page to the Web browser 22.

In contrast, dotted arrows in FIG. 3 show the process flow in the case where a Web server performs the entire authentication process by itself with no use of the master Web server 30. As is shown with respect to the dotted arrows in FIG. 3, the Web server requests an ID and a password from the Web browser 22 by itself at step S20. When the ID and the password are provided through the Web browser 22, the Web server compares the ID and the password with those in the user directory that the Web server maintains at step S22. If the ID and the password are determined to be valid, the Web server provides the requested access-restricted Web page to the Web browser 22.

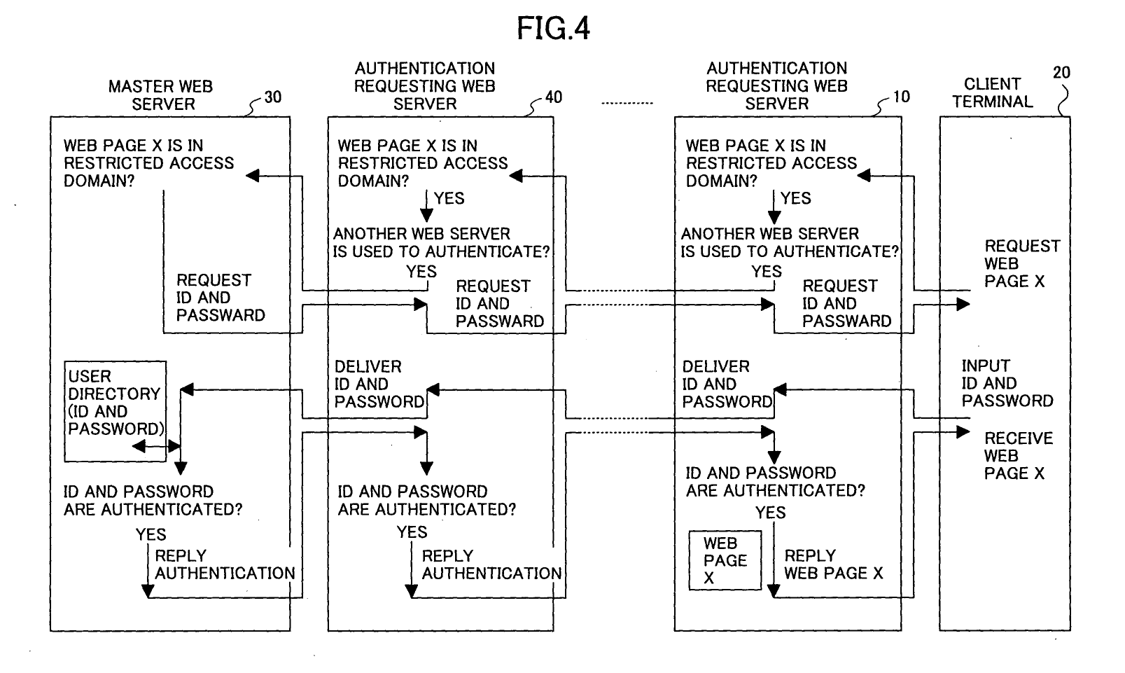

FIG. 4 shows a case where some Web servers recursively perform the authentication process according to the present invention. In this case, when a user requests an access-restricted Web page in the restricted access domain 16 in the authentication requesting Web server 10 through the client terminal 20, the authentication requesting Web server 10 accesses not the master Web server directly as mentioned above but another authentication requesting Web server 40. Then, the authentication requesting Web server 40 delivers the authentication request to the next authentication requesting Web server. Finally, the authentication request arrives at the master Web server 30 via at least one authentication requesting Web server 40.

When the master Web server 30 receives the authentication request, the ID and password request is replied from the master Web server 30 to the authentication requesting Web server 10 via the above-mentioned at least one authentication requesting Web server 40 in the inverse route of the authentication request delivery. Then, when the master Web server 30 provides the access authentication to the authentication requesting Web server 10 via the at least one authentication requesting server 40, the authentication requesting Web server 10 provides the requested access-restricted Web page to the client terminal 20.

In this fashion, even if the authentication process is performed between the authentication requesting Web server 10 and the master Web server 30 via at least one authentication requesting Web server 40, the master Web server 30 is responsible for performing the authentication process by comparing the input ID and the input password with the authentication information registered with the master Web server 30 in advance.

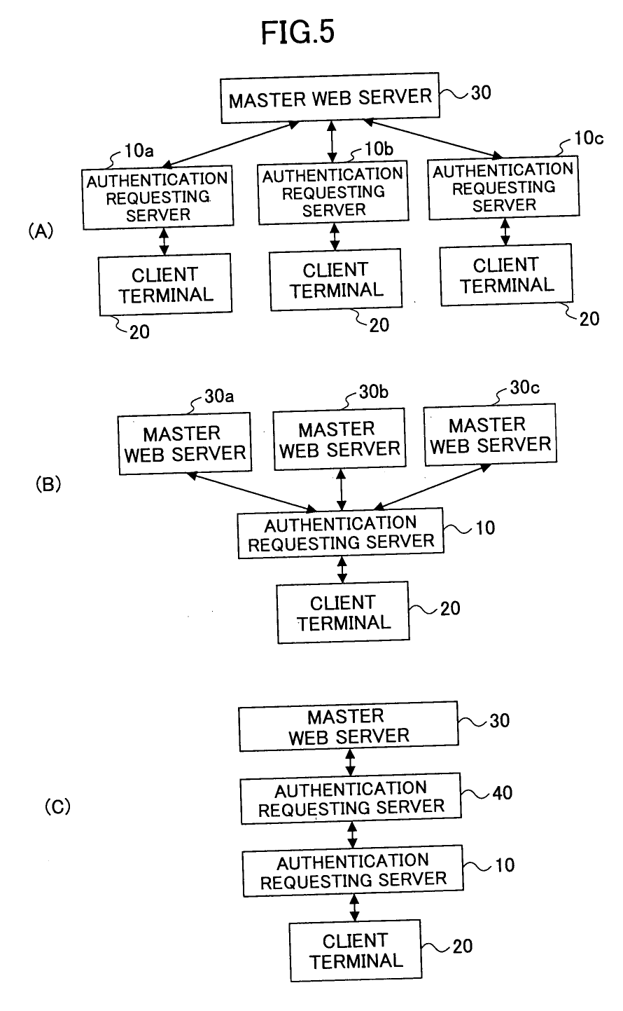

FIGS. 5A through 5C show typical configuration patterns of the authentication requesting Web servers 10 and the master Web servers 30.

In the configuration patter in FIG. 5A, a plurality of authentication requesting Web servers 10a through 10c use one master Web server 30.

In the configuration pattern in FIG. 5B, one authentication requesting Web server 10 refers to a plurality of master Web servers 30a through 30c. In this case, the authentication requesting Web server 10 has restricted access domains 16a through 16c each of which has access-restricted Web pages different from the other restricted access domains. In addition, authentication requested Web server's URL definition domains 15a through 15c are provided in the authentication requesting Web server 10 corresponding to the restricted access domains 16a through 16c, respectively. Then, the authentication requesting Web server 10 refers to the corresponding master Web servers 30a through 30c, respectively.

In the configuration pattern in FIG. 5C, the authentication requesting Web server 10 requests authentication to the authentication requesting Web server 40, and the authentication requesting Web server 40, in turn, requests the authentication to the master Web server 30. In principle, this configuration is similar to that shown in FIG. 4. Here, although FIG. 5C illustrates the case where one authentication requesting Web server 40 is sandwiched between the authentication requesting Web server 10 and the master Web server 30, a plurality of the authentication requesting Web servers 40 may be provided therein.

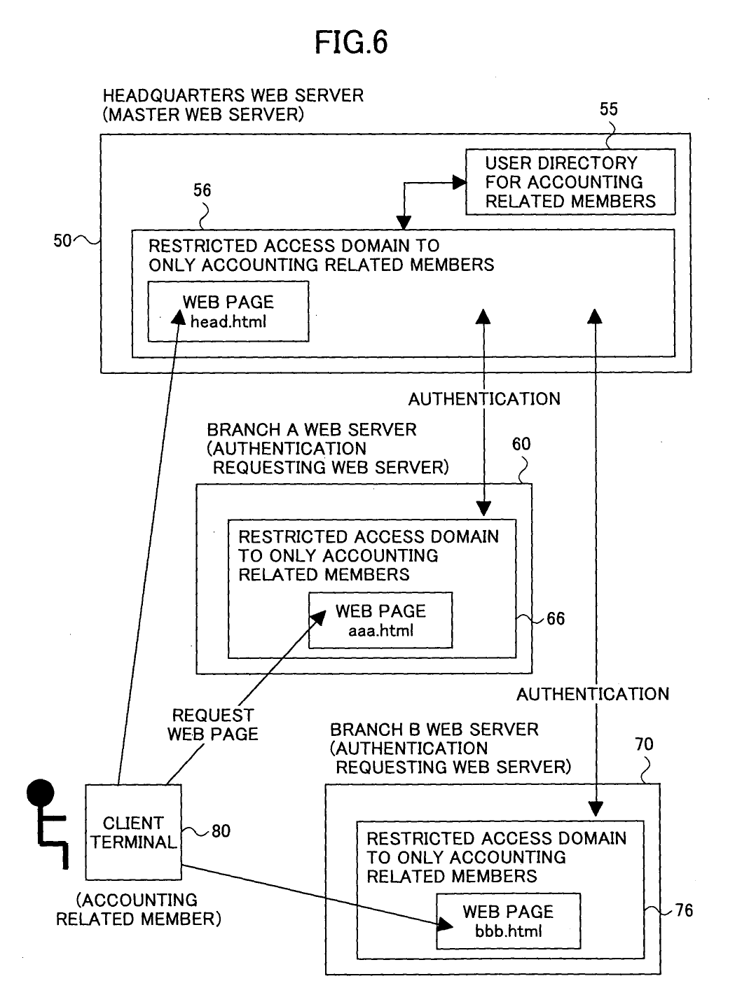

FIG. 6 shows the system structure of an authentication apparatus according to the first embodiment of the present invention. In this embodiment, the authentication apparatus is provided in a company. A headquarters Web server 50 works as a master Web server. The headquarters Web server 50 has a restricted access domain 56 that only accounting related members are allowed to access and a user directory 55 wherein IDs and passwords of all the accounting related members in the headquarters and all the branches are registered.

On the other hand, branch Web servers 60 and 70 are provided as authentication requesting Web servers. In this system structure, it is possible to offer a Web page that only accounting related members in the individual branches are allowed to access with reference to the restricted access domain 56 in the headquarters Web server 50. It is unnecessary to individually register the IDs and the passwords to the branch Web servers 60 and 70.

It is supposed that the headquarters Web server 50 allows the accounting related members in the headquarters and all the branches to access an arbitrary access-restricted Web page in the restricted access domain 56. Then, if the branch Web servers 60 and 70 register the corresponding URL to restricted access domains 66 and 76, respectively, the branch Web servers 60 and 70 can provide the access-restricted Web page from the restricted access domains 66 and 76 under the same access restriction (an ID and a password of an accounting related member) as the headquarters Web server 50.

If the accounting related member inputs the ID and the password through a client terminal 80, the accounting related member can access an access-restricted Web page in the restricted access domains 56, 66 and 76 in the Web servers 50, 60 and 70 in accordance with predetermined access authority of the accounting related member.

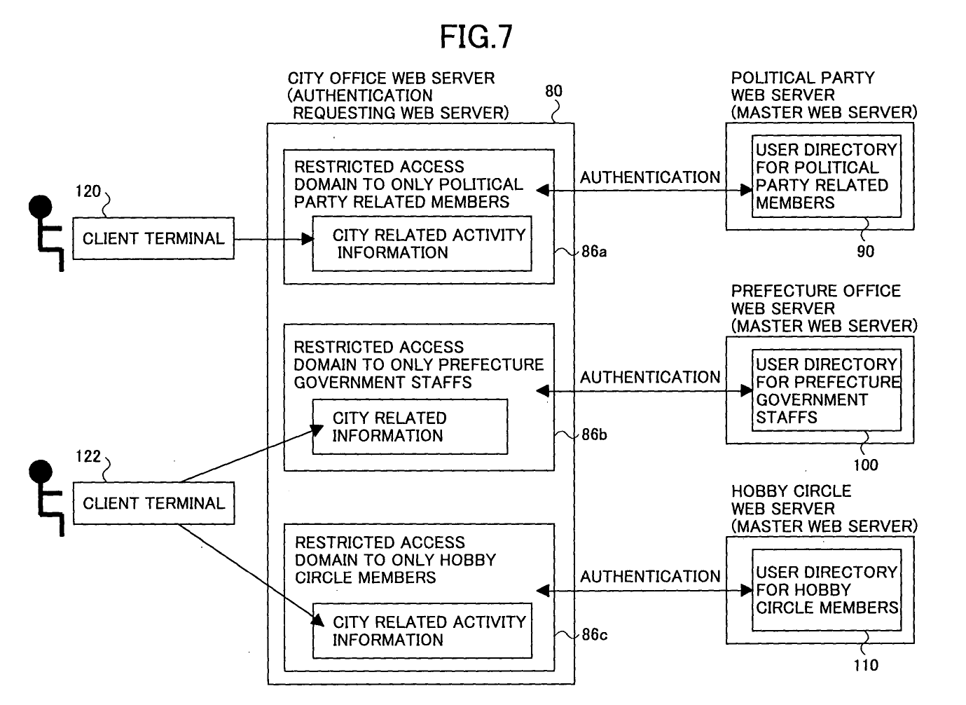

FIG. 7 shows the system structure of an authentication apparatus according to the second embodiment of the present invention. In this embodiment, the authentication apparatus is embodied in Web servers in public facilities. Here, various groups and communities are allowed to establish Web sites of the groups and communities in a city office Web server 80. In this case, the city office Web server 80 works as an authentication requesting Web server.

On the other hand, a political party Web server 90, a prefecture office Web server 100 and a hobby circle Web server 110 work as master Web servers. The political party Web server 90, the prefecture office Web server 100 and the hobby circle Web server 110 have a user directory 95 to which IDs and passwords of all political party related members are registered, a user directory 105 to which IDs and passwords of all prefecture government staffs are registered, and a user directory 115 to which IDs and passwords of all members in the hobby circle are registered, respectively.

The city office Web server 80 has restricted access domains 86a through 86c that only members in the groups and communities are allowed to access corresponding to the political party Web server 90, the prefecture office Web server 100 and the hobby circle Web server 110, respectively. In addition, the city office Web server 80 has authentication requested Web server's URL definition domains corresponding to these restricted access domains 86a through 86c and provides access-restricted Web pages in the restricted access domains 86a through 86c for each of the groups and communities, respectively.

In this system configuration, a member in the groups and communities accesses the city office Web server 80 through client terminals 120 and 122. The city office Web server 80 refers to the URL corresponding to the member's request among the political party Web server 90, the prefecture office Web server 100 and the hobby circle Web server 110 and performs the authentication process with reference to the ID and the password of the member. If the ID and the password are valid, the city office Web server 80 provides the member with the requested access-restricted Web page in one of the restricted access domains 86a through 86c in accordance with the group and community to which the member belongs.

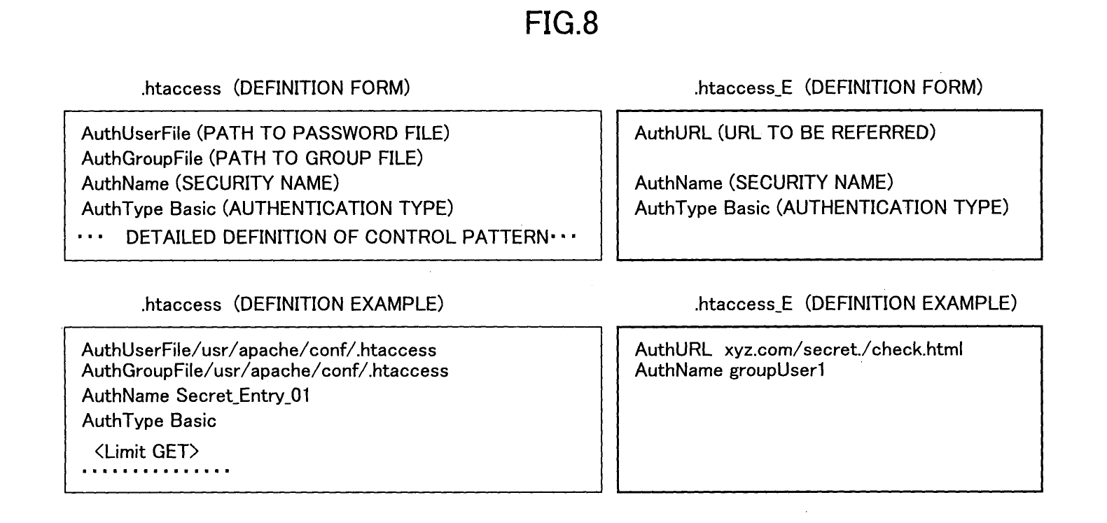

FIG. 8 shows an example of an authentication requested Web server's URL definition. FIG. 8 shows an authentication requested Web server's URL definition file “.htaccess_E” defined by the authentication requesting Web server 10 on the right side thereof and an access restriction definition file “.htaccess” used by a conventional UNIX (registered trademark) Web server on the left side thereof. Both of the files are provided in the top directory of restricted access domains of the Web servers. Here, definition forms and definition examples are illustrated on the top and the bottom of FIG. 8, respectively.

Some parameters in the authentication requested Web server's URL definition file “.htaccess_E” are defined as follows. The parameter “AuthURL” indicates a URL of a Web server to be referred to when the authentication process is performed. The parameter “AuthName” is an authentication title to be displayed. The parameter “AuthName” can be freely set because the title is simply used to display on the user's Web browser. The parameter “AuthType” indicates an authentication type and is not defined here. Since the authentication requesting Web server requests a user to input an ID and a password of the user in accordance with an authentication type designated by the master Web server, the authentication requesting function examines and uses the designated authentication type to request the user's input of the ID and the password.

According to the present invention, even if a plurality of Web servers provide an access-restricted Web page, a Web page user can access the access-restricted Web page by registering an ID and a password of the user to only the master Web server of the Web servers in advance. As a result, the user does not have to register the ID and the password for every one of the Web servers. Also, the user has less trouble remembering the ID and the password.

On the other hand, when a user attempts to open a Web site, the user can use an accessible and convenient Web server to easily open a Web site that only members in the user's group are allowed to access and distribute the information therein through a plurality of Web servers. Furthermore, since only one Web server can manage the IDs and the passwords of the members, it is possible to reduce the burden on an administrator of authentication information rather than the case where authentication information is managed in a plurality of servers.

Additionally, an administrator of a master Web server does not have to care for an authentication requesting Web server that refers to the master Web server. Also, since it is unnecessary to prepare a specified system for exchanging authentication information between the Web servers, the authentication process does not cause additional work load. Furthermore, since the cooperation of the Web servers uses URL information that may be opened, it is possible to conveniently handle information when the information is communicated via networks. Also, the Web servers may maintain the IDs and the passwords therein in the authentication method and the apparatus thereof according to the present invention. As a result, even if a currently used ordinary Web server is changed into an authentication requesting Web server, it is possible to manage the Web server in the conventional fashion.

It is noted that the authentication requesting Web server 10, the master Web server 30, the authentication requested Web server's URL definition domain 15 and the authentication requesting function 13 correspond to a first Web server, a second Web server, an authentication requested Web server registering part and an authentication requesting part, respectively, in the claims.

The present invention is not limited to the specifically disclosed embodiments, and variations and modifications may be made without departing from the scope of the present invention.

What is claimed is:

1. An authentication method for using a plurality of Web servers to allow only a user in a certain group to access information in said Web servers, wherein a first Web server in said Web servers has a restricted access domain that only the user in said certain group is allowed to access from a client terminal and does not have authentication information regarding the user, and a second Web server in said Web servers has the restricted access domain that only the user in said certain group is allowed to access and further has said authentication information registered thereto, comprising the steps of:
causing said first Web server to request authentication from said second Web server; and
allowing said user to access said restricted access domain in said first Web server from said client terminal based on an authentication result provided to said first Web server by said second Web server.

2. The authentication method as claimed in claim 1, wherein said first Web server delivers an authentication information request received from said second Web server to said client terminal and then delivers authentication information received from said client terminal for said authentication information request to said second Web server.

3. The authentication method as claimed in claim 1, wherein said second Web server receives an authentication request from a plurality of first Web servers.

4. The authentication method as claimed in claim 1, wherein said first Web server delivers an authentication request to a plurality of second Web servers.

5. The authentication method as claimed in claim 1, wherein said first Web server delivers an authentication request to another first Web server and said other first Web server delivers the authentication request to said second Web server.

6. An authentication apparatus for allowing only a user in a certain group to access information in a restricted access domain therein, comprising:
an authentication requested Web server registering part registering a Web server as an authentication requested Web server, said Web server having a same restricted access domain as said restricted access domain therein and further having authentication information regarding the user registered thereto; and
an authentication requesting part requesting authentication from said Web server with reference to said authentication requested Web server registering part when said authentication requesting part receives an access request for access to said restricted access domain therein from a client terminal of the user,
wherein said Web server determines whether or not said authentication is valid and said access request is allowed based on an authentication result determined by said Web server.

7. The authentication apparatus as claimed in claim 6, wherein said authentication requesting part delivers an authentication information request received from said Web server to said client terminal and delivers authentication information supplied in response to said authentication information request by said client terminal to said Web server.
